(19) United States
(12) Patent Application Publication
(10) Pub. No.: US 2014/0350211 A1
(43) Pub. Date: Nov. 27, 2014

(54) PROCESS FOR PRODUCING POLYESTERS

(71) Applicants: Andre Hennig, Ingelheim (DE); Thomas Schmied, Luetzelbach (DE); Juergen Luh, Ortenberg (DE); Thorsten Brand, Marl (DE); Guenter Schmitt, Darmstadt (DE); Michael Korell, Bochum (DE)

(72) Inventors: Andre Hennig, Ingelheim (DE); Thomas Schmied, Luetzelbach (DE); Juergen Luh, Ortenberg (DE); Thorsten Brand, Marl (DE); Guenter Schmitt, Darmstadt (DE); Michael Korell, Bochum (DE)

(73) Assignee: Evonik Industries AG, Essen (DE)

(21) Appl. No.: 14/367,014

(22) PCT Filed: Dec. 10, 2012
(86) PCT No.: PCT/EP2012/074930

§ 371 Date: Jun. 19, 2014

(30) Foreign Application Priority Data
Dec. 19, 2011 (DE) 10 2011 089 056.4

(51) Int. Cl. C08G 63/78; C08G 63/199; C08G 63/183; C08G 63/08; C08G 63/52

(52) U.S. Cl. CPC C08G 63/785; C08G 63/08; C08G 63/52; C08G 63/183; C08G 63/199
USPC 528/296; 528/272; 528/354; 528/306; 528/308.6; 528/308

(57) ABSTRACT

The present invention relates to a process for producing high-molecular-weight copolyesters with use of a kneader.

The present invention relates to a process for producing high-molecular-weight copolyesters with use of a kneader.

Copolyesters, here also termed polyesters for simplicity, have a wide variety of end uses. They are used, for example, as a constituent in adhesives, as binders for metal coatings, for example internal coatings of cans for preserving foods, as binders for foil coating and also as a constituent in foil production.

Industrial production of polyesters generally uses polycondensation reactions of appropriate di- or polycarboxylic acids with diols or polyols, i.e. reaction of molecules having at least two reactive terminal groups, where a small molecule is eliminated during the synthesis, an example being water or lower alcohols. The polycondensation reactions mentioned are generally carried out batchwise, i.e. the appropriate starting materials are reacted with one another in suitable apparatus, for example a tank or a tank cascade, with formation of the polyesters. The polycondensation reaction is usually carried out at temperatures of from 150 to 280° C. within a period of from 3 to 30 hours, and operations here can be carried out in vacuo after elimination of most of the theoretical amount of water arising. It is optionally also possible to operate with addition of catalysts to accelerate the condensation reactions and/or entrainer to remove the water of reaction. The processes mentioned have the disadvantage that they can only be carried out batchwise and that the reaction conditions cannot be adjusted to achieve all of the desired properties of the polyester. This is true in particular for polyesters with relatively high melt viscosity; the method mentioned cannot produce these in a manner which is cost-effective and which gives uniform product properties.

WO 2011/062600 describes a process for producing typically crystalline polyesters with relatively high melt viscosity by firstly, in a two-stage process, producing polyesters by a conventional method in the batch process, and then reacting them by postcondensation in a kneader to give polyesters with relatively high melt viscosity. The process mentioned is firstly very complicated by virtue of the multistage procedure, forming the desired polyesters only after remelting of the polyesters in an appropriate downstream reaction at 260° C., and secondly the viscosity of the starting material for postcondensation is already high enough to complicate the handling of the melt. Furthermore, the high processing temperature used in the postcondensation can lead to decomposition reactions of the polyester and thus terminate the molecular-weight increase or cause increased acid numbers in the final product or increased colour values.

It is an object of the present invention to provide a simplified and efficient process which can produce in particular high-molecular-weight copolyesters and which permits easy achievement of the desired properties of the copolyesters, inter alia low acid numbers. At the same time, the production process is intended to permit maximization of conversion rates, in order to allow increased efficiency in the synthesis of copolyesters and also to render these available in sufficient quantity.

Processes according to the present invention achieve the above object.

The present invention therefore provides processes for producing copolyesters, where, in a first step, di- and/or polycarboxylic acids are reacted with mono- or polyhydric alcohols, and/or lactones are reacted and, in a second step, a polycondensation is carried out, where the second step takes place in a kneader.

Surprisingly, it has been found that polyesters with the desired properties are obtained when the actual polycondensation is not carried out in the conventional manner in a stirred-tank reactor, but instead is carried out in a kneader. An advantage of the procedure according to the invention is that the copolyesters according to the invention with the desired properties can be produced rapidly and energy-efficiently. Surprisingly, this is also achieved with low-viscosity precursors which can be introduced into the kneader. Furthermore, the production of the copolyesters is successful not only in batch operation but also in continuous operation, and can be operated in a manner appropriate to the requirements of cost-effectiveness. Furthermore, the procedure according to the invention permits the production of copolyesters with low acid number, which are difficult to obtain by conventional processes of the prior art. This low acid number allows the use of the polyesters in the abovementioned application sectors, particularly in metal coating. It has moreover been found, surprisingly, that the process according to the invention gives copolyesters with reduced discoloration. Because of this reduced discoloration, the copolyesters produced according to the invention can also be used in applications with stringent optical requirements. Furthermore, it has surprisingly been found that the process has a broad range of application in respect of the monomer constitution of the copolyesters.

For the purposes of the present invention it is preferable to produce amorphous polyesters by the process according to the invention. For the purposes of the present invention, amorphous polyesters are polyesters which exhibit only a 2nd order phase transition at a glass transition temperature Tg, measured by differential scanning calorimetry (DSC), without simultaneously exhibiting any crystalline or semicrystalline behaviour, i.e. with no discernible other melting points in DSC. A particular feature of amorphous polyesters is that melt viscosity falls only slowly as temperature rises above the glass transition temperature. In contrast, melt viscosity rises steeply with rising molecular weight, and high process temperatures around 260° C. or higher are therefore usually necessary in order to produce the products.

Di- and/or polycarboxylic acids used can comprise any of the organic acids that are known to the person skilled in the art, having two or more carboxy functionalities. For the purposes of the present invention, the term carboxy functionalities also means derivatives thereof, for example esters.

The di- and/or polycarboxylic acids can involve saturated or unsaturated aliphatic or saturated or unsaturated cycloaliphatic di- and/or polycarboxylic acids. The di- and/or polycarboxylic acids can moreover also involve functionalized di- and/or polycarboxylic acids, for example hydroxy-functionalized di- and/or polycarboxylic acids. The aliphatic di- and/or polycarboxylic acids used can be linear or branched. The unsaturated cycloaliphatic di- and/or polycarboxylic acids in particular involve aromatic di- and/or polycarboxylic acids.

Examples of linear aliphatic di- and/or polycarboxylic acids comprise oxalic acid, dimethyl oxalate, malonic acid, dimethyl malonate, succinic acid, dimethyl succinate, glutaric acid, dimethyl glutarate, 3,3-dimethylglutaric acid, adipic acid, dimethyl adipate, pimelic acid, suberic acid, azelaic acid, dimethyl azelate, sebacic acid, dimethyl sebacate, undecanedioic acid, 1,10-decanedicarboxylic acid, 1,11-undecanedicarboxylic acid (brassylic acid), 1,12-dodecanedicarboxylic acid, hexadecanedioic acid, tridecanedioic acid, tetradecanedioic acid, octadecanedioic acid, dimer fatty acids and mixtures thereof.

Examples of unsaturated linear di- and/or polycarboxylic acids comprise fumaric acid, maleic acid and maleic anhydride.

Examples of saturated cycloaliphatic di- and/or polycarboxylic acids comprise derivatives of 1,4-cyclohexanedicarboxylic acids, 1,3-cyclohexanedicarboxylic acids and 1,2-cyclohexanedicarboxylic acids.

Suitable examples of aromatic di- and/or polycarboxylic acids are phthalic acid, isophthalic acid, terephthalic acid, 2,6-naphthalenedicarboxylic acid, 2,5-furandicarboxylic acid, trimellitic acid, ester derivatives thereof and anhydrides thereof.

Among the suitable examples of hydroxy-functionalized di- and/or polycarboxylic acids are by way of example glycolic acid, 3-hydroxypropionic acid, 2-hydroxyisobutyric acid, 3-hydroxyisobutyric acid, 2-hydroxycaproic acid, 2-hydroxycapric acid, 2-hydroxystearic acid, 12-hydroxystearic acid, (9Z)-12-hydroxy-9-octadecenoic acid (12-hydroxyoleic acid), (9Z,12R)-12-hydroxy-9-octadecenoic acid (ricinoleic acid), 14-hydroxyeicosanoic acid, (S)-2-hydroxyeicosanoic acid ((S)-a-hydroxyarachidonic acid) and (11Z,14R)-14-hydroxy-11-eicosenoic acid (lesquerolic acid), lactic acid, lactide, E-caproic acid.

A particular example of a suitable lactone is ε-caprolactone.

It is particularly preferable that the di- and/or polycarboxylic acids used comprise adipic acid, dimethyl adipate, sebacic acid, dimethyl sebacate, phthalic acid, isophthalic acid, terephthalic acid, 2,6-naphthalenedicarboxylic acid, trimellitic acid, ester derivatives thereof or anhydrides thereof.

Other compounds suitable for producing the polyesters are monobasic carboxylic acids, where these can be used for molecular-weight regulation. Examples of compounds suitable for this purpose are saturated and unsaturated fatty acids and benzoic acid. Examples of saturated and unsaturated fatty acids are stearic acid, palmitic acid, coconut fatty acid, myristic acid, lauric acid, pelargonic acid, myristoleic acid, palmitoleic acid, icosenic acid, oleic acid, linoleic acid and linolenic acid and mixtures of these.

The nature of the mono- or polyhydric alcohols used for producing the polyesters is not per se subject to any restriction. In particular, diols or polyols are involved. Polyols are compounds which preferably bear more than two hydroxy groups.

Linear or branched aliphatic and/or cycloalpihatic and/or aromatic diols or polyols can therefore be present.

Examples of suitable diols or polyols are ethylene glycol, 1,2-propanediol, 1,3-propanediol, 1,4-butanediol, 1,3-butanediol, 1,2-butanediol, 2,3-butanediol, 1,5-pentanediol, 1,6-hexanediol, 1,8-octanediol, 1,9-nonanediol, 1,12-dodecanediol, neopentyl glycol, butylethyl-1,3-propanediol, methyl-1,3-propanediol, methylpentanediols, cyclohexanedimethanols, tricyclo[2.2.1]decanedimethanol, isosorbitol, trimethylolpropane, glycerol, 1,2,6-hexanetriol, pentaerythritol, isomers of limonenedimethanol and mixtures thereof.

Aromatic diols or polyols are reaction products of aromatic polyhydroxy compounds, e.g. hydroquinone, bisphenol A, bisphenol F, dihydroxynaphthalene, etc. with epoxides, e.g. ethylene oxide or propylene oxide. Other diols or polyols that can be present are etherdiols, i.e. oligomers and, respectively, polymers based by way of example on ethylene glycol, propylene glycol or 1,4-butanediol.

Other compounds suitable for producing the polyesters are moreover monohydric fatty alcohols, where these can be used for molecular-weight regulation. Examples of those than can be used are eicosanol, stearyl alcohol, cetyl alcohol, myristyl alcohol and lauryl alcohol.

Particular preference is given to the aliphatic and cycloaliphatic diols or polyols, in particular ethylene glycol, 1,2-propanediol, 1,3-propanediol, 1,4-butanediol, 1,5-pentanediol, 1,6-hexanediol, neopentyl glycol, butylethyl-1,3-propanediol, methyl-1,3-propanediol, methylpentanediols, cyclohexanedimethanols, tricyclo[2.2.1]decanedimethanol, trimethylolpropane, limonenedimethanol and mixtures thereof.

The preferably amorphous polyesters produced by the procedure according to the invention are in particular preferably composed of at least one di- and/or polycarboxylic acid and of at least one diol or polyol, where the entirety of all of the di- and/or polycarboxylic acids and diols or polyols always gives a total of 100 mol %. The molar ratio of the di- and/or polycarboxylic acids to the diol component or polyol component in the polyester produced according to the invention is from 1:1.50 to 1:1.01, in particular from 1:1.35 to 1:1.05.

The di- and/or polycarboxylic acids component here is in particular composed of
1) at least 35 to 100 mol %, preferably from 45 to 98 mol %, of an aromatic di- and/or polycarboxylic acid, or its anhydrides or esters, where the aromatic di- and/or polycarboxylic acids mentioned can be used individually or in the form of mixture, and di- and/or polycarboxylic acids having more than two carboxylic acid functionalities are also optionally used
   and
2) at least 0 to 65 mol %, preferably from 2 to 55 mol %, of saturated and/or unsaturated aliphatic or cycloaliphatic di- and/or polycarboxylic acids, in particular dicarboxylic acids, or their anhydrides or esters, where the saturated and/or unsaturated aliphatic or cycloaliphatic di- and/or polycarboxylic acids mentioned may be used individually or in the form of a mixture
   and
3) optionally up to 5 mol % of a monocarboxylic acid, in particular benzoic acid or unsaturated or saturated fatty acids, for example stearic acid, palmitic acid, coconut fatty acid, myristic acid, lauric acid, pelargonic acid, myristoleic acid, palmitoleic acid, icosenoic acid, oleic acid, linoleic acid or linolenic acid.

The diol component or polyol component here is in particular composed of
1) at least 10 to 90 mol %, preferably from 20 to 70 mol %, of a linear aliphatic diol, particular diols that can be used being ethylene glycol, 1,3-propanediol, 1,4-butanediol, 1,5-pentanediol, 1,6-hexanediol, 1,8-octanediol, 1,9-nonanediol and 1,12-dodecanediol, individually or in the form of a mixture,
   and
2) at least 10 to 90 mol %, preferably from 30 to 80 mol %, of a branched aliphatic or cycloaliphatic diol or polyol, particular diols that can be used being 1,2-propanediol, 1,3-butanediol, 1,2-butanediol, neopentyl glycol, butylethyl-1,3-propanediol, methyl-1,3-propanediol, methylpentanediols, cyclohexanedimethanols, tricyclo[2.2.1]decanedimethanol, limonenedimethanol, and the polyols trimethylolpropane and pentaerythritol, individually or in the form of a mixture,
   and
3) optionally up to 5 mol % of an aromatic diol or polyol or of an etherdiol, in particular dihydroxynaphthalene, ethylene glycol oligomers or polymers of 1,4-butanediol or mixtures of both
   and
4) optionally up to 5 mol % of a fatty alcohol, such as eicosanol, stearyl alcohol, cetyl alcohol, myristyl alcohol or lauryl alcohol.

The polyesters produced according to the invention are in particular characterized by an OH number in the range from 0.1 to 15 mg KOH/g, preferably from 3 to 10 mg KOH/g.

The hydroxy number (OHN) is determined in accordance with DIN 53240-2. In this method, the specimen is reacted with acetic anhydride in the presence of 4-dimethylaminopyridine as catalyst, whereupon the hydroxy groups are acetylated. One molecule of acetic acid is produced for each hydroxy group here, while the subsequent hydrolysis of the excess acetic anhydride provides two molecules of acetic acid. The consumption of acetic acid is determined titrimetrically from the difference between the principle value and a blind value to be determined in parallel.

The acid number (AN) of the polyester produced according to the invention is in particular in the range from 0.1 to 3 mg KOH/g, preferably from 0.1 to 1.2 mg KOH/g. The acid number is determined in accordance with DIN EN ISO 2114. The acid number (AN) is the amount in mg of potassium hydroxide required to neutralize the acids present in one gram of substance. The specimen to be investigated is dissolved in dichloromethane and titrated with 0.1 N methanolic potassium hydroxide solution in the presence of phenolphthalein.

The viscosity number (VN) of the polyesters produced according to the invention is in particular in the range from 40 to 180 cm³/g, preferably from 50 to 120 cm³/g. The VN is a measure used for the relative determination of molecular weight, where the viscosity number (VN) in cm³/g is the relative viscosity change of a dilute polymer solution in relation to the pure solvent mixture, based on the concentration by mass of the polymer. The VN is determined in accordance with DIN 53728. For the purposes of the present invention, the VN is determined using a mixture of phenol/ortho-dichlorobenzene (50/50% by weight). The concentration by mass is 0.5 g of polymer in 100 cm³ of solvent mixture.

The number-average molar mass (M_{N}) of the polyesters produced according to the invention is preferably in the range from 9000 to 35 000 g/mol, preferably from 10 000 to 30 000 g/mol. The mass-average molar mass (M_{W}) is in particular in the range from 30 000 to 100 000 g/mol, preferably from 35 000 to 80 000 g/mol. Molar mass is determined by means of gel permeation chromatography (GPC). The specimens were characterized in tetrahydrofuran as eluent in accordance with DIN 55672-1.

Mₙ (UV)=number-average molar mass (GPC, UV detection), stated in g/mol
M_{w} (UV)=mass-average molar mass (GPC, UV detection), stated in g/mol.

The glass transition temperature (Tg) of the polyesters produced according to the invention is preferably from 35 to 150° C., preferably from 40 to 130° C. Glass transition temperature T_{g} is determined by means of DSC (differential scanning calorimetry) in accordance with DIN EN ISO 11357-1. The values stated are taken from a second heating cycle.

The softening point of the polyesters produced according to the invention is in the range from 100 to 200° C., in particular in the range from 120 to 180° C. The softening point is determined by the ring-and-ball method in accordance with DIN EN 1427.

In a first step in the process according to the invention, di- and/or polycarboxylic acids are transesterified and/or esterified with mono- or polyhydric alcohols, and/or lactones are reacted, and the term transesterification or esterification is also used for this below, in particular when a transesterification catalyst or esterification catalyst is present. Diol adducts of the di- or polycarboxylic acids are thus produced, while water or eliminated alcohols are removed by distillation.

For this, the appropriate starting materials are introduced into a suitable reaction vessel, for example a tank.

Suitable catalysts for this step are known to the person skilled in the art. Examples of suitable compounds are zinc compounds, tin compounds, titanium compounds or phosphorus compounds and mixtures of these, and particular compounds used are zinc(II) compounds, in particular zinc acetate, zinc chloride, tin(II) or tin(IV) compounds, in particular tin(II) octoate, tin(II) chloride, monobutylstannic acid, dibutyltin oxide, butyltin dihydroxychloride or butyltin tris(2-ethylhexoate), or titanium compounds, in particular butyl titanate, propyl titanate, octylene glycol titanate or Tyzer TEP. The amount of the catalytically active species used is generally from 2.5 ppm to 100 ppm, in particular from 10 ppm to 75 ppm, based on the polyester, where the ppm data are based on mass (ppm by mass).

The transesterification and/or esterification is generally carried out at a temperature in the range from 165° C. to 230° C., in particular from 175° C. to 225° C.

The product from the first step has low viscosity at the processing temperatures and in particular has the following properties:
OHN: from 30 to 150 mg KOH/g, preferably from 45 to 130 mg KOH/g
AN: from 0.1 to 30 mg KOH/g, preferably from 0.1 to 20 mg KOH/g
VN: from 7 to 25 cm³/g, preferably from 10 to 20 cm³/g
Mn (GPC): from 500 to 5000, preferably from 1500 to 4000
Mw (GPC): from 1500 to 10 000, preferably from 2000 to 7500
Melt viscosity (150° C.): from 0.05 to 2 Pas, preferably from 0.15 to 1.5 Pas

The melt viscosity of the product from the first reaction step is determined with an MC 301 plate-on-plate viscometer from Anton Paar at the abovementioned temperature. The diameter of the plates is 25 mm, their distance from one another is 1000 mm and the shear rate is 100/s. The polymer melts exhibit Newtonian behaviour within the parameters stated, i.e. the viscosity does not change when the shear rate changes.

The first step, the transesterification and/or esterification, is followed by the second step, the polycondensation, which according to the invention is carried out in a kneader.

Examples of a suitable kneader are single- or twin-shaft kneaders, rotating-disc-reactors, and also single- or twin-screw extruders, product input to which, and product output from which, can take place batchwise or continuously. For the purposes of the present invention, the generic term kneaders also covers rotating-disc reactors. Kneaders feature a wide residence-time range with high operating volume, very good mixing properties due to high torque, good self-cleaning properties of the surfaces, and also good temperature control of the reaction mixture due to large heating/cooling area.

The rotation of the kneader shaft(s) subjects the polymer melt to a constant process of dispersion, mixing, reintegration and conveying, in such a way that material is constantly transported to the surface and returned to the interior of the melt.

Twin-shaft kneader reactors as revealed by way of example in DE 199 40 521 A1, DE 101 50 900, DE 41 18 884 A1 or EP 0 853 491 are also particularly suitable for carrying out the process according to the invention. An advantage of these reactors is that the rotating shafts generate a high level of surface renewal of the polymer melt throughout the entire processing length. This greatly accelerates the vacuum-driven withdrawal of the cleavage products across the vapour space in the kneader, when comparison is made with the conventional reactors, and this in turn accelerates the construction of the polymer chain. The kneader reactors are optimized in relation to self-cleaning and avoidance of dead zones. The selection of the type of kneading protuberances is moreover preferably such that interaction between the kneading or mixing protuberances does not produce any compression zones. The entire process should proceed continuously. Controlled, axial conveying of the viscous mass takes place here (plug flow). Various shaft geometries can be selected here. The conveying angles of the kneading protuberances can be adapted appropriately and serve for the axial conveying of the mass within the reactor. It is moreover possible to incorporate reverse-conveying zones, where these control the fill level within the reactor. Reverse-conveying zones of this type can also bring about back-mixing.

Suitable rotating-disc reactors are mostly cylindrical, horizontal, heated containers with input and output connections for the transesterification material and the polycondensate at the opposite ends of the rotating-disc reactor. Located in the rotating-disc reactor there is a large number of elements which rotate around a horizontal axis and which mix the transesterification material and generate a large surface for evolution of gases from the polycondensate via run-off of the viscous melt adhering on the said elements. Apparatus of this type have been described in the German Patent Applications 1 745 541, 1 720 692, 2 100 615 and 2 114 080, and also in the European Patents and Patent Applications 0 320 586, 0 719 582, 0 711 597 and 1 386 659.

The polymer is processed through the kneader until the desired properties, such as molecular weight and characteristic values of the polyester, have been achieved.

Suitable polycondensation catalysts are known to the person skilled in the art. Examples of suitable compounds are zinc compounds, germanium dioxide, antimony triacetate, and titanium compounds, and in particular zinc acetate, germanium dioxide, or titanium compounds, in particular butyl titanate, propyl titanate, octylene glycol titanate or Tyzer TEP, are used. The amount of the catalytically active species used is generally from 2.5 ppm to 100 ppm, in particular from 10 ppm to 75 ppm, based on the polyester, where the ppm data are based on mass (ppm by mass).

The total amount of the catalytically active species from the transesterification and/or esterification and the polycondensation is from 5 ppm to 150 ppm, based on the polyester, where the ppm data are based on mass (ppm by mass).

The residence time of the polymer in the kneader depends on many parameters and is generally from 5 minutes to 8 hours, preferably from 20 minutes to 5 hours.

The polycondensation in the kneader can be carried out at reduced pressure, in particular in the range from 0.1 mbar to 100 mbar.

The shaft rotation rate of the kneader can be in the range from 5 rpm to 200 rpm, in particular from 40 rpm to 150 rpm.

The temperatures of the polymer melt are preferably from 220° C. to 245° C. These low temperatures permit not only production of the polyesters under non-aggressive conditions in such a way that there is no, or hardly any, expectation of decomposition reactions, but also energy-efficient production of the polyesters, and they therefore make a contribution to the conservation of natural resources. Very surprisingly, this method can moreover also give copolyesters with little discoloration and low acid number. A first result of the decomposition reactions caused by high levels of thermal stress on the polyester melt, and discernible from an increased acid number and from increased colour indices, is that the desired molecular weight cannot be achieved, and secondly discolored products are also often unsuitable in the abovementioned applications.

The present invention also provides the polyesters produced by the process according to the invention. They are particularly suitable for use as primary binders, ancillary binders, or an additional component in metal coating, foil production, foil coating, e.g. by means of extrusion coating, and adhesive production.

It is assumed that, even without further information, a person skilled in the art can make very extensive use of the description above. The preferred embodiments and examples are therefore to be interpreted merely as descriptive, and certainly not as in any way limiting disclosure.

### EXAMPLES

### Transesterification and Esterification

### Inventive Example 1

3604 g of dimethyl terephthalate (DMT) (18.58 mol), 1571 g of 1,2-propanediol (PD-1,2) (20.67 mol), 943 g of 1,3-propanediol (PD-1,3) (12.41 mol) and 1323 g of butylethyl-1,3-propanediol (BEPD) (8.27 mol) are heated together with 3.50 g of monobutylstannic acid (MBSA) in a 10 l batch metal apparatus with filler neck, distillation bridge and vacuum connection until elimination of methanol begins (from 165 to 185° C.). The reaction mixture is then further heated in such a way that the overhead temperature remains constant at from 65 to 70° C. Once elimination of methanol has concluded, 1285 g of isophthalic acid (IPA) (7.74 mol) and 678 g of adipic acid (AD) (4.64 mol) are added at an internal temperature of 180° C., and the mixture is further heated until elimination of water begins at about 200° C. This is continued until the overhead temperature falls again to below 85° C. Table 1 collates the properties of the transesterification and esterification product.

### Inventive Example 2

1812 g of dimethyl terephthalate (DMT) (9.34 mol), 203 g of monoethylene glycol (MEG) (3.28 mol), 1717 g of neopentyl glycol (NPG) (16.51 mol) and 357 g of cyclohexanedimethanol 90 (CHDM 90) (2.23 mol) are heated together with 0.90 g of zinc acetate in a 10 l batch metal apparatus with filler neck, distillation bridge and vacuum connection until elimination of methanol begins (from 165 to 185° C.). The reaction mixture is then further heated in such a way that the overhead temperature remains constant at from 65 to 70° C. Once elimination of methanol has concluded, 1550 g of isophthalic acid (IPA) (9.34 mol) are added at an internal temperature of 180° C. and the mixture is heated further. At about 210° C. elimination of water begins, and this is continued until the overhead temperature falls again to below 85° C. Table 1 collates the properties of the transesterification and esterification product.

### Inventive Example 3

2986 g of isophthalic acid (IPA) (17.99 mol), 2264 g of 2,6-naphthalenedicarboxylic acid (10.48 mol), 16 g of trimellitic anhydride (TMA) (0.08 mol), 676 g of 1,4-butanediol (BD-1,4) (7.51 mol), 698 g of monoethylene glycol (MEG) (11.26 mol), 1562 g of neopentyl glycol (NPG) (15.02 mol) and 601 g of cyclohexanedimethanol 90 (CHDM 90) (3.76 mol) are heated together with 2.80 g of octylene glycol titanate (OGT) in a 10 l batch metal apparatus with filler neck, distillation bridge and vacuum connection until elimination of water begins (185 to 195° C.). Elimination of water is continued until the overhead temperature falls again to below 85° C. Table 1 collates the properties of the transesterification and esterification product.

### Inventive Example 4

3604 g of dimethyl terephthalate (DMT) (18.58 mol), 1319 g of 1,4-butanediol (BD-1,4) (14.66 mol) and 2873 g of tricyclo[2.2.1]decanedimethanol (TCD-DM) (14.66 mol) are heated together with 5.80 g of octylene glycol titanate (OGT) in a 101 batch metal apparatus with filler neck, distillation bridge and vacuum connection until elimination of methanol begins (from 150 to 165° C.). The reaction mixture is then further heated in such a way that the overhead temperature remains constant at from 65 to 70° C. Once elimination of methanol has concluded, the overhead temperature falls to below 65° C. Table 1 collates the properties of the transesterification product.

### Inventive Example 5

1848 g of dimethyl terephthalate (DMT) (9.53 mol), 1039 g of 2-methyl-1,3-propanediol (MPD) (11.54 mol), 2078 g of 1,4-butanediol (BD-1,4) (23.09 mol) and 239 g of monoethylene glycol (MEG) (3.85 mol) are heated together with 3.50 g of octylene glycol titanate (OGT) in a 10 l batch metal apparatus with filler neck, distillation bridge and vacuum connection until elimination of methanol begins (from 180 to 190° C.). The reaction mixture is then further heated in such a way that the overhead temperature remains constant at from 65 to 70° C. Once elimination of methanol has concluded, 1581 g of isophthalic acid (IPA) (9.52 mol) and 1955 g of hexahydrophthalic anhydride (HHPA) (12.69 mol) are added at an internal temperature of 180° C. An increase in the reaction temperature causes elimination of water to begin at about 210° C., and this is continued until the overhead temperature falls again to below 85° C. Table 1 collates the properties of the transesterification and esterification product.

TABLE 1
Characteristic values of the transesterification and/or esterification products

| Characteristic | Inv. | Inv. | Inv. | Inv. | Inv. |
|---|---|---|---|---|---|
| values | Ex. 1 | Ex. 2 | Ex. 3 | Ex. 4 | Ex. 5 |
| OHN [mg KOH/g] | 138 | 81 | 158 | 95 | 79 |
| AN [mg KOH/g] | 8 | 16 | 13 | 0.2 | 28 |
| Mn [g/mol] | 1500 | 1800 | 800 | 1200 | 1400 |
| Mw [g/mol] | 2200 | 3300 | 1600 | 2500 | 2500 |
| Melt viscosity | 0.5 | 1.1 | 0.15 | 0.9 | 0.15 |
| [Pa•s] | | | | | |
| Tg [° C.] | −4 | 39 | 9 | 36 | −2 |

### Polycondensation

### A) Condensation in a List Kneader (CRP4konti from List)

A1) Batch process: about 4 kg of molten transesterification and/or esterification product are premixed with the catalyst (0.1% by weight) and the mixture is then transferred by way of a heated pipeline into the List kneader. After this has been filled it is heated to the condensation temperature, and when the operating temperature is reached the reactor internal pressure is lowered within 30 minutes to the prescribed value. The condensation is carried out at a constant rotation rate of the kneader shafts until the prescribed molecular weight has been reached or until the melt viscosity has reached its maximum rise. Tables 2 and 3 give the process data and the characteristic values of the products.

TABLE 2
Process data for condensation method A1)

| Parameter | Inv. Ex. 1A1 | Inv. Ex. 2A1 | Inv. Ex. 3A1 | Inv. Ex. 4A1 |
|---|---|---|---|---|
| Temperature | 230 | 235 | 235 | 240 |
| (internal) | | | | |
| Rotation rate | 120 | 120 | 110 | 125 |
| Residence time | 270 | 125 | 85 | 210 |
| (min.) | | | | |
| Vacuum/mbar | <1 | <1 | <1 | <1 |
| Catalyst/ | | | | |
| amount (wt %) | OGT/0.05 | ZnOAc/0.05 | OGT/0.06 | OGT/0.08 |

TABLE 3
Characteristic values for condensation method A1)

| Characteristic | | | | |
|---|---|---|---|---|
| values | Inv. Ex. 1A1 | Inv. Ex. 2A1 | Inv. Ex. 3A1 | Inv. Ex. 4A1 |
| OHN [mg KOH/g] | 7.0 | 7.4 | 2.1 | n.m. |
| AN [mg KOH/g] | 0.7 | 0.8 | 0.8 | 1.2 |
| Mn [g/mol] | 10100 | 11400 | 11100 | 29500 |
| Mw [g/mol] | 3100 | 40800 | 36400 | 60600 |
| VN [cm³/g] | 58 | 62 | 57 | 80 |
| Tg [° C.] | 34 | 71 | 66 | 104 |

A2) Continuous process: The mixture of transesterification and/or esterification product and catalyst is introduced continuously at constant shaft rotation rate into a reactor preheated to operating temperature and evacuated to operating pressure, and the mass inflow rate is determined here. The product is discharged until steady-state conditions have been established. Steady-state conditions are constantly re-established here by varying the process parameters.

The characteristic values of the products in Table 5 relate to the stated process data under steady-state conditions (Table 4).

TABLE 4
Process data for condensation method A2)

| Parameter | Inv. Ex. 2A2 | Inv. Ex. 4A2 |
|---|---|---|
| Temperature | 210 | 245 |
| (internal) | | |
| Rotation rate | 57 | 125 |
| Residence time | 225 | 255 |
| (min.) | | |
| Vacuum/mbar | 30 | <1 |
| Catalyst/ | | |
| amount (wt %) | ZnOAc/0.05 | OGT/0.08 |

ZnOAc- zinc (II) acetate

TABLE 5
Characteristic values for condensation method A2)

| Characteristic | | |
|---|---|---|
| values | Inv. Ex. 2A2 | Inv. Ex. 4A2 |
| OHN [mg KOH/g] | 7.9 | n.m. |
| AN [mg KOH/g] | 1.2 | 0.9 |
| Mn [g/mol] | 11200 | 22500 |
| Mw [g/mol] | 39400 | 49300 |
| VN [cm³/g] | 58 | 73 |
| Tg [° C.] | 70 | 98 |

### Comparative Examples

### B) Condensation in a 10 l Stirred Metal Tank by the Batch Process

The condensation catalyst is admixed with the polymer melt after transesterification and esterification, and the mixture is homogenized and heated to the condensation temperature, and then the reactor internal pressure is lowered to <1 mbar within a period of 30 minutes. Once the prescribed molecular weight, or the maximum achievable melt viscosity, has been reached, the tank is emptied by using nitrogen at superatmospheric pressure. Tables 6 and 7 give the process data and the characteristic values of the products.

TABLE 6
Process data for condensation method B)

| | Comp. | Comp. | Comp. | Comp. |
|---|---|---|---|---|
| Parameter | Ex. 1 | Ex. 2 | Ex. 3 | Ex. 4 |
| Temperature | 245 | 265 | 245 | 270 |
| (internal) | | | | |
| Rotation rate | 70 | 70 | 70 | 70 |
| Residence time | 380 | 705 | 680 | 590 |
| (min.) | | | | |
| Vacuum/mbar | <1 | <1 | 1.2 | <1 |
| Catalyst/ | OGT/0.05 | ZnOAc/0.04 | OGT/0.06 | OGT/0.08 |
| amount (wt %) | | | | |

ZnOAc- zinc(II) acetate

TABLE 7
Characteristic values for condensation method B)

| Characteristic | Comp. | Comp. | Comp. | Comp. |
|---|---|---|---|---|
| values | Ex. 1 | Ex. 2 | Ex. 3 | Ex. 4 |
| OHN [mg KOH/g] | 5.7 | 7.2 | 3.5 | n.m. |
| AN [mg KOH/g] | 1.7 | 1.8 | 1.2 | 3.3 |
| Mn [g/mol] | 11200 | 10400.0 | 11100 | 11300.0 |
| Mw [g/mol] | 41500 | 35500.0 | 33400 | 36300.0 |
| VN [cm³/g] | 63 | 55 | 54 | 59 |
| Tg [° C.] | 36 | 69 | 66 | 106 |

n.m. = not measurable

### C) Condensation in the (Lurgi) Rotating-Disc Reactor by the Batch Process

An appropriate amount of condensation catalyst is admixed with the melt of the transesterification and/or esterification product, and the mixture is homogenized, heated to condensation temperature, and introduced into the rotating-disc reactor. The internal reactor pressure is lowered to <1 mbar within a period of 30 minutes, and once the prescribed molecular weight, discernible via the rise in the melt viscosity within the reactor, has been reached the condensation is terminated and the material is discharged from the reactor. Use of a rotating-disc reactor also gives polyesters according to the present invention, and the residence times here likewise can be markedly reduced when comparison is made with the processes of the prior art.

1. A process for producing a polyester, the process comprising
reacting a di- and/or polycarboxylic acid (DPA) with a mono- or polyhydric alcohol (MPOH), or ring-opening a lactone, thereby producing an ester, and,
conducting a polycondensation reaction on said ester in a kneader to produce a polyester.

2. The process of claim 1, comprising reacting a DPA with an MPOH wherein the DPA is at least one selected from the group consisting of saturated or unsaturated aliphatic or saturated or unsaturated cycloaliphatic di- and/or polycarboxylic acids.

3. The process of claim 2, wherein the DPA is functionalized.

4. The process of claim 2, wherein the DPA is at least one selected from the group consisting of adipic acid, dimethyl adipate, sebacic acid, dimethyl sebacate, phthalic acid, isophthalic acid, terephthalic acid, 2,6-naphthalenedicarboxylic acid, trimellitic acid, and the ester and anhydride derivatives thereof.

5. The process of claim 2, wherein the MPOH is selected from the group consisting of linear and branched aliphatic and/or cycloaliphatic and/or aromatic diols and polyols, and mixtures thereof.

6. The process of claim 5, wherein said MPOH is selected from the group consisting of ethylene glycol, 1,2-propanediol, 1,3-propanediol, 1,4-butanediol, 1,5-pentanediol, 1,6-hexanediol, neopentyl glycol, butylethyl-1,3-propanediol, methyl-1,3-propanediol, methylpentanediols, cyclohexanedimethanols, tricyclo[2.2.1]decanedimethanol, trimethylolpropane, isomers of limonenedimethanol and mixtures thereof.

7. The process of claim 1, wherein said polyester has an OH number from 0.1 to 15 mg KOH/g.

8. The process of claim 1, wherein said polyester has an acid number (AN) from 0.1 to 3 mg KOH/g.

9. The process of claim 1, wherein said polyester has a number average molar mass (M_{N}) from 9000 to 35 000 g/mol.

10. The process of claim 1, wherein said polyester has a mass-average molar mass (M_{W}) from 30 000 to 100 000 g/mol.

11. The process of claim 1, wherein the kneader is selected from the group consisting of a single-shaft kneader, a twin-shaft kneader, a rotating-disc reactor, a single-screw extruder, and a twin-screw extruder.

12. The process of claim 1, wherein ester resides in the kneader from 5 minutes to 8 hours.

13. The process of claim 1, wherein the polycondensation reaction occurs in the kneader at a pressure from 0.1 mbar to 100 mbar.

14. The process of claim 1, wherein the internal mixing rate of the kneader is from 5 rpm to 200 rpm.

15. A polyester, produced by the process of claim 1.

16. The process of claim 1, comprising
ring-opening a lactone thereby producing an ester, and,
conducting a polycondensation reaction on said ester in a kneader to produce a polyester.
